(19) United States
(12) Patent Application Publication
(10) Pub. No.: US 2015/0324448 A1
(43) Pub. Date: Nov. 12, 2015

(54) Information Recommendation Processing Method and Apparatus

(71) Applicant: Huawei Technologies Co., Ltd., Shenzhen (CN)

(72) Inventors: Zhihong Qiu, Shenzhen (CN); Quan Qi, Shenzhen (CN)

(21) Appl. No.: 14/795,189

(22) Filed: Jul. 9, 2015

Related U.S. Application Data
(63) Continuation of application No. PCT/CN2014/074403, filed on Mar. 31, 2014.

(30) Foreign Application Priority Data
May 8, 2013 (CN) 201310165715.8

(51) Int. Cl. G06F 17/30

(52) U.S. Cl. CPC G06F 17/30598; G06F 17/30324; G06F 17/30424

(57) ABSTRACT

An information recommendation processing method and apparatus, where the method includes: acquiring an information set, where the information set includes multiple pieces of to-be-recommended information, and the to-be-recommended information includes a time stamp that is used to identify generation time of the to-be-recommended information; dividing, according to information about an information recommendation time range and the time stamps corresponding to the multiple pieces of to-be-recommended information, the multiple pieces of to-be-recommended information in the information set into to-be-recommended information within the range and to-be-recommended information out of the range; and determining, among the to-be-recommended information within the range, to-be-recommended information used for recommendation. In this case, a time stamp of the information is taken into consideration for information recommended to the user, thereby achieving high timeliness of the information recommended to the user.

### CROSS-REFERENCE TO RELATED APPLICATIONS

This application is a continuation of International Application No. PCT/CN2014/074403, filed on Mar. 31, 2014, which claims priority to Chinese Patent Application No. 201310165715.8, filed on May 8, 2013, both of which are hereby incorporated by reference in their entireties.

### TECHNICAL FIELD

The present invention relates to communications technologies, and in particular, to an information recommendation processing method and apparatus.

### BACKGROUND

With continuous development of the Internet, the amount of information on the Internet experiences an explosive growth; the information is updated at an increasingly high frequency; and when a user browses web pages, diverse information is presented to and overwhelms the user. Particularly, in the e-commerce field, with a continuous increase in scale of the e-commerce and a rapid growth in the quantity and category of goods, a customer needs to spend a lot of time in finding goods that the customer wants to buy. Such a process of browsing a large quantity of irrelevant information and products undoubtedly causes loss of consumers who are submerged in an information overloading problem. In the Internet browsing field, with development of blogs, wikis, and microblogs, a large amount of network information is generated by individual users. The information is poorly organized, and the quality and reliability of such information are unstable, so that the user needs to spend a lot of time in finding information that the user is interested in.

In the prior art, to resolve the foregoing problems, a personalized recommendation manner is used to recommend, to a user, information and goods that the user is interested in.

However, as information update becomes increasingly fast, in the prior art, information recommended to the user is most often out-of-date information, which causes the burden of information browsing to the user.

### SUMMARY

Embodiments of the present invention provide an information recommendation processing method and apparatus, which are used to resolve a problem of recommending out-of-date information to a user.

According to a first aspect, an embodiment of the present invention provides an information recommendation processing method, including acquiring an information set, where the information set includes multiple pieces of to-be-recommended information, and the to-be-recommended information includes a time stamp that is used to identify generation time of the to-be-recommended information; dividing, according to information about an information recommendation time range and the time stamps corresponding to the multiple pieces of to-be-recommended information, the multiple pieces of to-be-recommended information in the information set into to-be-recommended information within the range and to-be-recommended information out of the range; and determining, among the to-be-recommended information within the range, to-be-recommended information used for recommendation, where time identified by the time stamp of the to-be-recommended information within the range is included in the information recommendation time range.

With reference to the first aspect, in a first possible implementation manner of the first aspect, the determining, among the to-be-recommended information within the range, to-be-recommended information used for recommendation includes acquiring at least one keyword included in the to-be-recommended information within the range, and acquiring, according to the number of pieces of to-be-recommended information within the range, the number of pieces of to-be-recommended information out of the range, the number of the keywords included in the to-be-recommended information within the range, and the number of the keywords included in the to-be-recommended information out of the range, an information gain corresponding to the keyword; and determining, according to the information gain, among the to-be-recommended information within the range, the to-be-recommended information used for recommendation.

With reference to the first possible implementation manner of the first aspect, in a second possible implementation manner of the first aspect, the determining, according to the information gain, among the to-be-recommended information within the range, the to-be-recommended information used for recommendation includes acquiring, according to the information gain corresponding to the keywords included in the to-be-recommended information within the range, digital vectors corresponding to the multiple pieces of to-be-recommended information within the range; and forming a digital vector matrix according to the digital vectors corresponding to the multiple pieces of to-be-recommended information within the range, applying a preset clustering or classification algorithm, and acquiring to-be-recommended information within the range used for recommendation.

With reference to the second possible implementation manner of the first aspect, in a third possible implementation manner of the first aspect, the method further includes screening the to-be-recommended information within the range according to the information gain corresponding to the keywords, and acquiring digital vectors corresponding to screened to-be-recommended information within the range; and correspondingly, the forming a digital vector matrix according to the digital vectors corresponding to the multiple pieces of to-be-recommended information within the range includes forming the digital vector matrix according to the digital vectors corresponding to the screened to-be-recommended information within the range.

With reference to any one of the first aspect to the third implementation manner of the first aspect, in a fourth possible implementation manner of the first aspect, the acquiring an information set includes acquiring, according to a search word, multiple pieces of to-be-recommended information to form the information set, where the search word includes a search word input by a user, or a search word extracted from association information of the user.

According to a second aspect, an embodiment of the present invention provides an information recommendation processing apparatus, including an acquiring module configured to acquire an information set, where the information set includes multiple pieces of to-be-recommended information, and the to-be-recommended information includes a time stamp that is used to identify generation time of the to-be-recommended information; a dividing module configured to divide, according to information about an information recommendation time range and the time stamps corresponding to the multiple pieces of to-be-recommended information, the multiple pieces of to-be-recommended information in the information set into to-be-recommended information within the range and to-be-recommended information out of the range; and a recommending module configured to determine, among the to-be-recommended information within the range, to-be-recommended information used for recommendation, where time identified by the time stamp of the to-be-recommended information within the range is included in the information recommendation time range.

With reference to the second aspect, in a first possible implementation manner of the second aspect, the recommending module is specifically configured to acquire at least one keyword included in the to-be-recommended information within the range, acquire, according to the number of pieces of to-be-recommended information within the range, the number of pieces of to-be-recommended information out of the range, the number of the keywords included in the to-be-recommended information within the range, and the number of the keywords included in the to-be-recommended information out of the range, an information gain corresponding to the keyword, and determine, according to the information gain, among the to-be-recommended information within the range, the to-be-recommended information used for recommendation.

With reference to the first possible implementation manner of the second aspect, in a second possible implementation manner of the second aspect, the recommending module further includes an acquiring unit configured to acquire, according to the information gain corresponding to the keywords included in the to-be-recommended information within the range, digital vectors corresponding to the multiple pieces of to-be-recommended information within the range; and a recommending unit configured to form a digital vector matrix according to the digital vectors corresponding to the multiple pieces of to-be-recommended information within the range, apply a preset clustering or classification algorithm, and acquire to-be-recommended information within the range used for recommendation.

With reference to the second possible implementation manner of the second aspect, in a third possible implementation manner of the second aspect, the apparatus further includes a screening module configured to screen the to-be-recommended information within the range according to the information gain corresponding to the keywords, and acquire digital vectors corresponding to screened to-be-recommended information within the range, where the recommending unit is configured to form the digital vector matrix according to the digital vectors corresponding to the screened to-be-recommended information within the range.

With reference to any one of the second aspect to the third implementation manner of the second aspect, in a fourth possible implementation manner of the second aspect, the acquiring module is specifically configured to acquire, according to a search word, multiple pieces of to-be-recommended information to form the information set, where the search word includes a search word input by a user, or a search word extracted from association information of the user.

According to a third aspect, an embodiment of the present invention provides an information recommendation processing apparatus, including a memory and a processor, where the memory is configured to store an instruction; and the processor, which is coupled with the memory and configured to perform the instruction stored in the memory, is configured to acquire an information set, where the information set includes multiple pieces of to-be-recommended information, and the to-be-recommended information includes a time stamp that is used to identify generation time of the to-be-recommended information; divide, according to information about an information recommendation time range and the time stamps corresponding to the multiple pieces of to-be-recommended information, the multiple pieces of to-be-recommended information in the information set into to-be-recommended information within the range and to-be-recommended information out of the range; and determine, among the to-be-recommended information within the range, to-be-recommended information used for recommendation, where time identified by the time stamp of the to-be-recommended information within the range is included in the information recommendation time range.

With reference to the third aspect, in a first possible implementation manner of the third aspect, the processor is specifically configured to acquire at least one keyword included in the to-be-recommended information within the range; acquire, according to the number of pieces of to-be-recommended information within the range, the number of pieces of to-be-recommended information out of the range, the number of the keywords included in the to-be-recommended information within the range, and the number of the keywords included in the to-be-recommended information out of the range, an information gain corresponding to the keyword; and determine, according to the information gain, among the to-be-recommended information within the range, the to-be-recommended information used for recommendation.

With reference to the first possible implementation manner of the third aspect, in a second possible implementation manner of the third aspect, the processor is specifically configured to acquire, according to the information gain corresponding to the keywords included in the to-be-recommended information within the range, digital vectors corresponding to the multiple pieces of to-be-recommended information within the range; and form a digital vector matrix according to the digital vectors corresponding to the multiple pieces of to-be-recommended information within the range, apply a preset clustering or classification algorithm, and acquire to-be-recommended information within the range used for recommendation.

With reference to the second possible implementation manner of the third aspect, in a third possible implementation manner of the third aspect, the processor is further configured to screen the to-be-recommended information within the range according to the information gain corresponding to the keywords, acquire digital vectors corresponding to screened to-be-recommended information within the range, and form the digital vector matrix according to the digital vectors corresponding to the screened to-be-recommended information within the range.

With reference to any one of the third aspect to the third implementation manner of the third aspect, in a fourth possible implementation manner of the third aspect, the processor is specifically configured to acquire, according to a search word, multiple pieces of to-be-recommended information to form the information set, where the search word includes a search word input by a user, or a search word extracted from association information of the user.

In the embodiments of the present invention, to-be-recommended information that is acquired is divided, according to information about an information recommendation time range and time stamps corresponding to multiple pieces of to-be-recommended information, into to-be-recommended information within the range and to-be-recommended information out of the range, and to-be-recommended information used for recommendation is selected from the to-be-recommended information within the range for a user. In this case, a time stamp of the information is taken into consideration for information recommended to the user, thereby achieving high timeliness of the information recommended to the user.

### BRIEF DESCRIPTION OF DRAWINGS

To describe the technical solutions in the embodiments of the present invention or the prior art more clearly, the following briefly introduces the accompanying drawings required for describing the embodiments. The accompanying drawings in the following description show some embodiments of the present invention, and a person of ordinary skill in the art may still derive other drawings from these accompanying drawings without creative efforts.

FIG. 1 is a schematic flowchart of Embodiment 1 of an information recommendation processing method according to the present invention;

FIG. 2 is a schematic flowchart of Embodiment 2 of an information recommendation processing method according to the present invention;

FIG. 3 is a schematic structural diagram of Embodiment 1 of an information recommendation processing apparatus according to the present invention;

FIG. 4 is a schematic structural diagram of Embodiment 2 of an information recommendation processing apparatus according to the present invention;

FIG. 5 is a schematic structural diagram of Embodiment 3 of an information recommendation processing apparatus according to the present invention; and

FIG. 6 is a schematic structural diagram of Embodiment 4 of an information recommendation processing apparatus according to the present invention.

### DESCRIPTION OF EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. The described embodiments are merely a part rather than all of the embodiments of the present invention. All other embodiments obtained by a person of ordinary skill in the art based on the embodiments of the present invention without creative efforts shall fall within the protection scope of the present invention.

In the embodiments of the present invention, a symbol “*” represents a multiplication sign in a formula, a symbol “/” represents a division sign in a formula, and the symbol “/” represents an alternative relationship in a text.

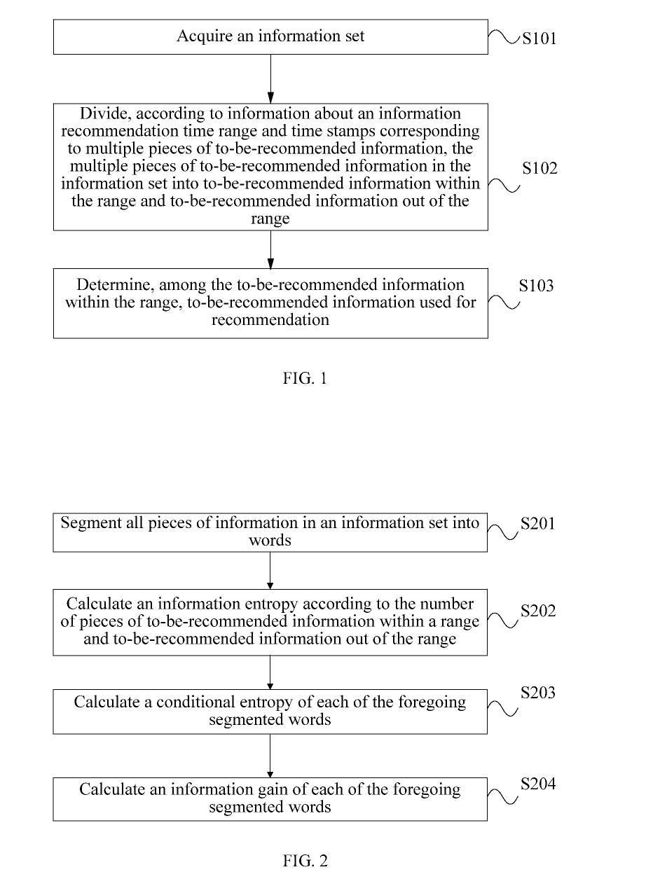

FIG. 1 is a schematic flowchart of Embodiment 1 of an information recommendation processing method according to the present invention. The method may be executed by an information recommendation processing apparatus, where the apparatus may be integrated into servers of different websites. As shown in FIG. 1, the process includes:

S101. Acquire an information set, where the information set includes multiple pieces of to-be-recommended information, and the to-be-recommended information includes a time stamp that is used to identify generation time of the to-be-recommended information.

Specifically, the information recommendation processing apparatus may acquire, by using a search engine, multiple pieces of information on websites, or directly and randomly acquire multiple pieces of information or all information of a website; and may also perform de-duplication on the acquired information to form an information set, where the de-duplication generally excludes information that is exactly the same.

S102. Divide, according to information about an information recommendation time range and the time stamps corresponding to the multiple pieces of to-be-recommended information, the multiple pieces of to-be-recommended information in the information set into to-be-recommended information within the range and to-be-recommended information out of the range.

It should be noted that time identified by the time stamp of the to-be-recommended information within the range is included in the information recommendation time range.

The information recommendation time range may be determined according to an attribute of the to-be-recommended information. For example, for “news”, the information recommendation time range is current day. The information recommendation time range may also be determined according to a record of recommending information to a user. For example, the user accesses a microblog at 8:00 a.m.; the microblog recommends some information to the user; the user accesses the microblog again at 12:00 at noon; recommendation information that is updated between 8:00 and 12:00 is recommended to the user. The information recommendation time range may further be determined according to a received time range input by the user. For example, the user accesses the microblog and sets a time option in a search engine of the microblog; the user may define or select a time range, and the microblog recommends, to the user, information within the time range input by the user.

These pieces of to-be-recommended information may be sorted according to the time stamps corresponding to the multiple pieces of to-be-recommended information in the information set, and these pieces of to-be-recommended information are divided into to-be-recommended information within the range and to-be-recommended information out of the range according to the information recommendation time range.

S103. Determine, among the to-be-recommended information within the range, to-be-recommended information used for recommendation.

After the to-be-recommended information within the range and the to-be-recommended information out of the range are determined, not all the to-be-recommended information within the range is recommended to the user; and the information within the range is screened again instead. For example, some hot information or information in which the user is interested is recommended to the user.

In this embodiment, to-be-recommended information that is acquired is divided, according to information about an information recommendation time range and time stamps corresponding to multiple pieces of to-be-recommended information, into to-be-recommended information within the range and to-be-recommended information out of the range, and to-be-recommended information used for recommendation is selected from the to-be-recommended information within the range for a user. In this case, a time stamp of the information is taken into consideration for information recommended to the user, thereby achieving high timeliness of the information recommended to the user.

FIG. 2 is a schematic flowchart of Embodiment 2 of an information recommendation processing method according to the present invention. In the foregoing step S103, the determining, among the to-be-recommended information within the range, to-be-recommended information used for recommendation is specifically: acquiring at least one keyword included in the to-be-recommended information within the range, and acquiring, according to the number of pieces of to-be-recommended information within the range, the number of pieces of to-be-recommended information out of the range, the number of the keywords included in the to-be-recommended information within the range, and the number of the keywords included in the to-be-recommended information out of the range, an information gain corresponding to the keyword; and determining, according to the information gain, among the to-be-recommended information within the range, the to-be-recommended information used for recommendation. In addition, besides an information gain-based algorithm, an algorithm based on term frequency, relative term frequency, or inverse document frequency may also be used. The to-be-recommended information used for recommendation is determined according to an occurrence frequency of words in the to-be-recommended information within the range and in the to-be-recommended information out of the range.

For example, the information gain corresponding to the keyword is acquired according to the number of pieces of to-be-recommended information within the range in the foregoing, the number of pieces of to-be-recommended information out of the range in the foregoing, the number of pieces of to-be-recommended information within the range in the foregoing that includes the keyword, and the number of pieces of to-be-recommended information out of the range in the foregoing that includes the keyword. Assuming that information “within a week” from the date of calculation is categorized as to-be-recommended information within the range, the number of pieces of to-be-recommended information within the range is 10640, and the number of pieces of to-be-recommended information out of the range is 105929. Specifically, the method includes:

S201. Segment all pieces of information in an information set into words, which may be specifically and separately performing division in a subset of to-be-recommended information within the range and a subset of to-be-recommended information out of the range after the to-be-recommended information within the range and the to-be-recommended information out of the range are divided. For example, one of the pieces of to-be-recommended information within the range is “#Favorite mobile phone brand # is certainly, aha, HUAWEI which is currently in use! Support China-made goods!”, which, after being segmented into words by using a word segmentation technology, is transformed into ten words, that is “Favorite, mobile phone, brand, is certainly, currently, in use, HUAWEI, aha, support, China-made goods”, where the stop word “which” is removed by using the word segmentation technology.

S202. Calculate an information entropy H(C) according to the number of pieces of to-be-recommended information within the range and the number of pieces of to-be-recommended information out of the range. Specifically, the information entropy is calculated by using formula (1): H(C)=−(p+)*log (p+)−(p−)*log (p−), where p+ represents a proportion of the to-be-recommended information within the range to the information set and p− represents a proportion of the to-be-recommended information out of the range to the information set. In this embodiment of the present invention, cases are only divided into two categories, that is, within the range and out of the range; therefore, the sum of p+ and p− is 1. Assuming that the number of pieces of to-be-recommended information within the range is 10640 and the number of pieces of to-be-recommended information out of the range is 105929, the total number of pieces of information in the information set is 126569. H(C)=−20640/126569*(log(20640/126569))−105929/126569*((log(105929/126569))).

S203. Calculate a conditional entropy H(C|T) of each of the foregoing segmented words. Assuming that “China-made goods” is a keyword, Table 1 shows a statistics result of the number of pieces of information that includes the keyword.

TABLE 1

| | To-be-recom- | To-be-recom- | |
|---|---|---|---|
| | mended infor- | mended infor- | Total number |
| | mation within | mation out of | of pieces of |
| | the range | the range | information |
| Information | 149 pieces | 889 pieces | 1038 pieces |
| that includes | | | |
| “China-made | | | |
| goods” | | | |
| Information | 20491 pieces | 105040 pieces | 125531 pieces |
| that does not | | | |
| include | | | |
| “China-made | | | |
| goods” | | | |
| Total number | 20640 pieces | 105929 pieces | 126569 pieces |
| of pieces of | | | |
| information | | | |

Formula (2) H(C|T)=P(t+)*H(C|t+)+P(t−)*H(C|t−) is used to calculate the foregoing conditional entropy, where H(C|T) represents a degree of uncertainty to which the information set is classified into to-be-recommended information within the range and to-be-recommended information out of the range on condition that whether each piece of information includes a word T is known. If the word T appears, it is marked as t+; if the word T does not appear, it is marked as t−; P(t+) represents a proportion of the number of pieces of information that includes the word T to the total number of pieces of information in the information set; H(C|t+) represents an information entropy of an information subset that includes the word T and is in the information set; P(t−) represents a proportion of the number of pieces of information that does not include the word T to the total number of pieces of information in the information set; and H(C|t−) represents an information entropy of an information subset that does not include the word T and is in the information set.

Formula (2) is expanded as formula (3) according to the foregoing formula (1): H(C|T)=P(t+)*(−(p+|t+)*log(p+|t+)−(p−|t+)*log(p−|t+))+P(t−)*(−(p+|t−)*log(p+|t−)−(p−|t−)*log(p−|t−)), where (p+|t+) represents a proportion of the number of pieces of to-be-recommended information that is within the range and includes the word T to the total number of pieces of information that includes the word T and is in the information set. The foregoing “China-made goods” is used as an example. (p+|t+)=20491/125531. Likewise, (p−|t+) represents a proportion of the number of pieces of to-be-recommended information that is out of the range and includes the word T to the total number of pieces of information that includes the word T and is in the information set; (p+|t−) represents a proportion of the number of pieces of to-be-recommended information that is within the range and does not include the word T to the total number of pieces of information that does not include the word T and is in the information set; and (p−|t−) represents a proportion of the number of pieces of to-be-recommended information that is out of the range and does not include the word T to the total number of pieces of information that does not include the word T and is in the information set.

S204. Calculate an information gain IG(T) of each of the foregoing segmented words. Specifically, the information gain is calculated according to formula (4) IG(T)=H(C)−H(C|T); according to the foregoing formula, formula (4) is expanded as formula (5): IG(T)=P(t+)*H(C|t+)+P(t−)*H(C|t−)−(P(t+)*(−(p+|t+)*log(p+|t+)−(p−|t+)*log(p−|t+))+P(t−)*(−(p+|t−)*log(p+|t−)−(p−|t−)*log(p−|t−))). The foregoing “China-made goods” is used as an example:

IG(China-made goods)=−20640/126569*(log(20640/126569))−105929/126569*((log(105929/126569)))−1038/126569*(−149/1038*(log(149/1038))−889/1038*(log(889/1038)))−125531/126569*(−20491/125531*(log(20491/125531))−105040/125531*(log(105040/125531))))=0.000017. This calculation formula is used to separately obtain, by calculation, the information gain of each of the foregoing segmented words, and the to-be-recommended information used for recommendation is selected according to the information gain obtained by calculation.

Further, the determining, according to the foregoing information gain and among the to-be-recommended information within the range, the to-be-recommended information used for recommendation is specifically: acquiring, according to information gains corresponding to the keywords included in to-be-recommended information within the range, digital vectors corresponding to the multiple pieces of to-be-recommended information within the range; and then forming a digital vector matrix according to the digital vectors corresponding to the multiple pieces of to-be-recommended information within the range, applying a preset clustering or classification algorithm, and acquiring to-be-recommended information within the range used for recommendation.

For example, after the foregoing information “#Favorite mobile phone brand # is certainly, aha, HUAWEI which is currently in use! Support China-made goods!” is transformed into “#Favorite, mobile phone, brand, is certainly, currently, in use, HUAWEI, aha, support, China-made goods”, and assuming that information gains of the 10 segmented words are successively 0.000001, 0.03, 0.004, 0.00006, 0.000008, 0.000001, 0.003, 0.0004, 0.000006, and 0.000017, a digital vector corresponding to this piece of information is {0.000001, 0.03, 0.004, 0.00006, 0.000008, 0.000001, 0.003, 0.0004, 0.000006, 0.000017}; all pieces of to-be-recommended information within the range are expressed as digital vectors; and a vector matrix is formed by these digital vectors. The acquired vector matrix may be input into a preset clustering or classification algorithm by using an existing clustering algorithm, such as a k-means algorithm or a hierarchical clustering algorithm, or an existing classification algorithm, such as a Naive Bayesian classification algorithm or a Bayesian networks classification algorithm. The k-means algorithm is used as an example. By using this algorithm, each piece of information is put into a corresponding class; a distance from each piece of information to a class center is obtained by calculation; and finally a piece of information that has the smallest distance to the class center is selected from each class and then recommended to a user. In this case, a class of information that includes the largest number of pieces of information may be selected and recommended to the user.

Table 2 is used as an example. Table 2 shows a part of results that a microblog website outputs for multiple pieces of microblogs by using the clustering algorithm, on the basis of processing in the foregoing embodiment:

TABLE 2

| Class | Distance to | |
|---|---|---|
| number | class center | Original text |
| 1 | 0.216215357 | /@Zhang San: A satisfying 2G mobile phone at the |
| | | cost of a 1G mobile phone@Li Si: Rush to buy it and |
| | | you will never regret for it. //@Vmall.com:#New |
| | | today in Vmall.com#[Huawei Mediapad 10 FHD - |
| | | a favorable advance sale package for the first |
| | | launch]Hi buddies, Huawei is nothing but |
| | | generous//@Vmall.com: Buddies, a higher version |
| | | with a 2G RAM and a 16G phone memory is on the |
| | | market altogether! For details: http://t.cn/zWEz9sw |
| 1 | 0.220000961 | //@Muranhuanxi: This is great! Empty JD |
| | | [Like]!//@Global IT Digital Rank: #Buy Huawei |
| | | phones to empty JD# MediaPad is extremely clear, |
| | | fast, genuine, light and slim, and outperforms NEW |
| | | PAD. Make a purchase at an extremely low price |
| | | without hesitation, and buy Huawei phones to empty JD! |
| 1 | 0.230278106 | @Aiyayahaofenhong The goods we talked about this |
| | | afternoon is on the market covertly . . . The price is |
| | | 2999 without a decimal 0.9 . . . Then the specifications |
| | | repeatedly mention the keyboard dock, which hints |
| | | that we may have to pay for it. Therefore, I am |
| | | extremely fed up . . . If there is a free keyboard dock |
| | | for sure, the e5 is fairly good. However, it is only a |
| | | probability, so think twice//@Huawei MediaPad: All |
| | | friends participating in the advance purchase in |
| | | Vmall.com and JD may get a Huawei E5 and match |
| | | it with a WiFi MediaPad 10 FHD for better experience! |
| 2 | 0.084241 | #A Huawei P1 makes a wiser and more beautiful |
| | | life#[bofu eating watermelon] Forwarding may bring |
| | | me good luck!!! @Yeerzhilan @Miss Bayueweiyang |
| | | @fox fen Address: http://t.cn/zW8kEDm |
| 2 | 0.084242 | #A Huawei P1 makes a wiser and more beautiful |
| | | life#[bofu eating watermelon] Forwarding may bring |
| | | me good luck!!! @Zhang San @Li Si Address: |
| | | http://t.cn/zW8kEDm |
| 2 | 0.084251 | # A Huawei P1 makes a wiser and more beautiful |
| | | life#[bofu eating watermelon] Forwarding may bring |
| | | me good luck!!! @Chengcheng |
| | | @Xiangwangtiankongdebai @gunananan Address: |
| | | http://t.cn/zW8kEDm |

The following two pieces of microblogs are recommended to the user according to the foregoing results: 1)/@Zhang San: A satisfying a second generation (2G) mobile phone at the cost of a first generation (1G) mobile phone.@Li Si: Rush to buy it and you will never regret for it.//@Vmall.com:#New today in Vmall.com#[Huawei Mediapad 10 full high-definition (FHD)—a favorable advance sale package for the first launch]Hi buddies, Huawei is nothing but generous//@Vmall.com: Buddies, a higher version with a 2 gigabytes (G) random access memory (RAM) and a 16 G phone memory is on the market altogether! For details: http://t.cn/zWEz9sw. 2)# A Huawei P1 makes a wiser and more beautiful life#[bofu eating watermelon]Forwarding may bring me good luck!!! @Yeerzhilan @Miss Bayueweiyang @fox fen Address: http://t.cn/zW8kEDm.

In addition, a semantic analysis tool may also be used to organize head words of each class into a piece of useful information after class clustering or classification, and the information is then recommended to the user.

Further, on the basis of the foregoing embodiment, the to-be-recommended information within the range may be screened according to the information gain corresponding to the keywords, and the digital vectors corresponding to screened to-be-recommended information within the range are acquired; correspondingly, the forming a digital vector matrix according to the digital vectors corresponding to the multiple pieces of to-be-recommended information within the range is specifically: forming the foregoing digital vector matrix according to the digital vectors corresponding to the screened to-be-recommended information. That is, after information gains of all words are obtained by calculation, the words may be sorted according to the values of information gains, and information in which a word whose information gain is less than a preset threshold is located may be deleted from the to-be-recommended information within the range, so as to avoid recommending some recurring junk information or advertisements, or the like, to the user. It may be seen from the foregoing embodiment that, the information that appears in a negative example is generally out-of-date information. Some recurring information may appear not only in the to-be-recommended information within the range, but also in the to-be-recommended information out of the range. For example, an advertisement is repeatedly played for a month and an information recommendation time range is a current day; then the number of occurrences of this advertisement in the to-be-recommended information out of the range is far greater than the number of occurrences of this advertisement in the to-be-recommended information within the range; information gains of words included in this advertisement that are obtained by calculation according to the foregoing formula (5) is certainly excessively low; and the advertisement is deleted instead of being recommended to the user when information is recommended to the user on the current day, which prevents the user from seeing some recurring information and out-of-date information.

Still further, the acquiring an information set may be acquiring, according to a search word, multiple pieces of to-be-recommended information to form the information set, where the search word may be: (1) a search word input by the user himself or herself; or (2) a search word extracted from association information of the user. In this case, the user's interest is taken into consideration before information is recommended to the user, so that the information recommended to the user is information that the user is interested in.

During a specific implementation process, in the foregoing manner (1), the user can directly input some search words in a search engine, and the search engine acquires relevant information. In the foregoing manner (2), a search word may be extracted from some user-defined information; for example, user-defined label information in a microblog can be directly extracted to serve as a search word; a search word may also be extracted according to a browsing record of the user; for example, the user recently browses history books on an e-commerce website for several times, and then “history book” can be used as the search word.

It should be noted that, some website servers, such as a microblog server, do not allow other search engines to perform large-scale information search on their websites. In this case, a search tool of the microblog may periodically use the foregoing search word to search for information; and information after de-duplication is locally saved and is acquired by an information recommendation processing apparatus through a dedicated search interface.

In this embodiment of the present invention, information in which a user is interested is acquired according to a search word associated with the user; to-be-recommended information that is acquired is divided, according to information about an information recommendation time range and time stamps corresponding to multiple pieces of to-be-recommended information, into to-be-recommended information within the range and to-be-recommended information out of the range, and to-be-recommended information used for recommendation is selected from the to-be-recommended information within the range for the user. In this case, a time stamp of the information is taken into consideration for information recommended to the user, thereby achieving high timeliness of the information recommended to the user. In addition, the to-be-recommended information within the range may be screened according to information gains of keywords, so as to remove some recurring information and junk information such as advertisement information.

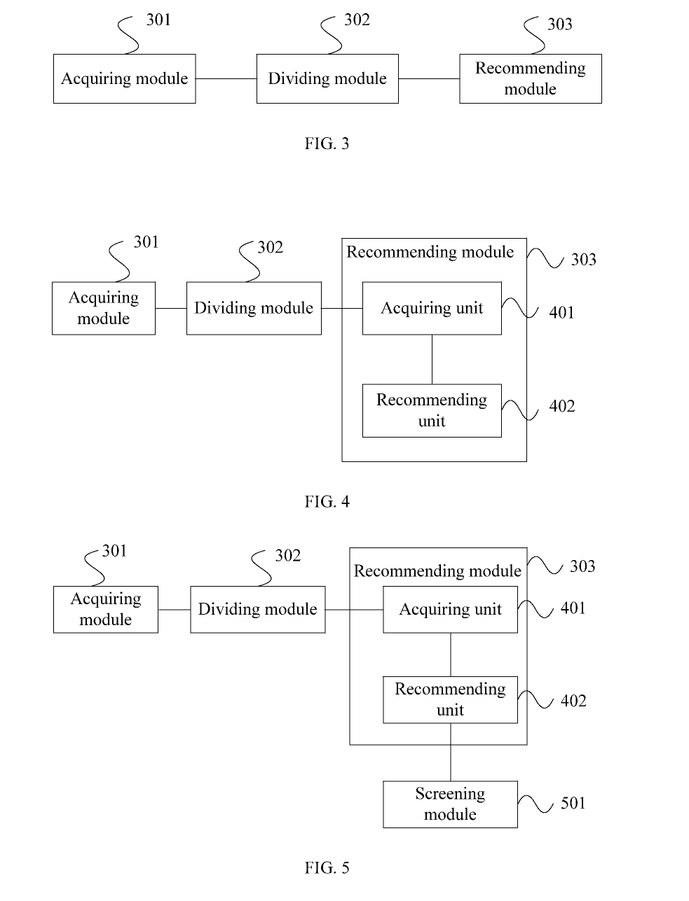

FIG. 3 is a schematic structural diagram of Embodiment 1 of an information recommendation processing apparatus according to the present invention. The apparatus may be integrated into servers of different websites As shown in FIG. 3, the apparatus includes an acquiring module 301, a dividing module 302, and a recommending module 303, where the acquiring module 301 is configured to acquire an information set, where the information set includes multiple pieces of to-be-recommended information, and the to-be-recommended information includes a time stamp that is used to identify generation time of the to-be-recommended information; the dividing module 302 is configured to divide, according to information about an information recommendation time range and the time stamps corresponding to the multiple pieces of to-be-recommended information, the multiple pieces of to-be-recommended information in the information set into to-be-recommended information within the range and to-be-recommended information out of the range; and the recommending module 303 is configured to determine, among the to-be-recommended information within the range, to-be-recommended information used for recommendation, where time identified by the time stamp of the to-be-recommended information within the range is included in the information recommendation time range.

The foregoing modules are configured to execute the method embodiment shown in FIG. 1. Implementation principles and technical effects are similar, and are not described herein again.

FIG. 4 is a schematic structural diagram of Embodiment 2 of an information recommendation processing apparatus according to the present invention. On the basis of FIG. 3, the recommending module 303 is specifically configured to acquire at least one keyword included in the to-be-recommended information within the range, acquire, according to the number of pieces of to-be-recommended information within the range, the number of pieces of to-be-recommended information out of the range, the number of the keywords included in the to-be-recommended information within the range, and the number of the keywords included in the to-be-recommended information out of the range, an information gain corresponding to the keyword, and determine, according to the information gain, among the to-be-recommended information within the range, the to-be-recommended information used for recommendation.

Further, as shown in FIG. 4, the recommending module 303 includes an acquiring unit 401 and a recommending unit 402, where the acquiring unit 401 is configured to acquire, according to information gains corresponding to the keywords included in the to-be-recommended information within the range, digital vectors corresponding to the multiple pieces of to-be-recommended information within the range; and the recommending unit 402 is configured to form a digital vector matrix according to the digital vectors corresponding to the multiple pieces of to-be-recommended information within the range, apply a preset clustering or classification algorithm, and acquire to-be-recommended information within the range used for recommendation.

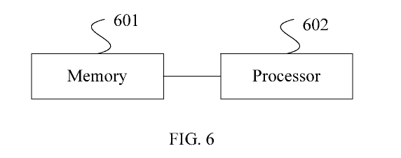

FIG. 5 is a schematic structural diagram of Embodiment 3 of an information recommendation processing apparatus according to the present invention. As shown in FIG. 5, on the basis of FIG. 4, the apparatus further includes a screening module 501, where the screening module 501 is configured to screen the to-be-recommended information within the range according to the information gain corresponding to the keywords, and acquire digital vectors corresponding to screened to-be-recommended information within the range; and the foregoing recommending unit 402 is configured to form the digital vector matrix according to the digital vectors corresponding to the screened to-be-recommended information within the range.

Further, the foregoing acquiring module 301 is specifically configured to acquire, according to a search word, multiple pieces of to-be-recommended information to form the information set, where the search word includes a search word input by the user, or a search word extracted from association information of the user.

The foregoing modules are configured to execute the foregoing method embodiments. Implementation principles and technical effects are similar and are not described herein again.

FIG. 6 is a schematic structural diagram of Embodiment 4 of an information recommendation processing apparatus according to the present invention. As shown in FIG. 6, the apparatus includes a memory 601 and a processor 602. The memory 601 is configured to store an instruction, and the processor 602 is coupled with the memory and configured to perform the instruction that is stored in the memory. Specifically, the processor 602 is configured to acquire an information set, where the information set includes multiple pieces of to-be-recommended information, and the to-be-recommended information includes a time stamp that is used to identify generation time of the to-be-recommended information; divide, according to information about an information recommendation time range and the time stamps corresponding to the multiple pieces of to-be-recommended information, the multiple pieces of to-be-recommended information in the information set into to-be-recommended information within the range and to-be-recommended information out of the range; and determine, among the to-be-recommended information within the range, to-be-recommended information used for recommendation, where time identified by the time stamp of the to-be-recommended information within the range is included in the information recommendation time range.

Further, the processor 602 is specifically configured to acquire at least one keyword included in the to-be-recommended information within the range; acquire, according to the number of pieces of to-be-recommended information within the range, the number of pieces of to-be-recommended information out of the range, the number of the keywords included in the to-be-recommended information within the range, and the number of the keywords included in the to-be-recommended information out of the range, an information gain corresponding to the keyword; and determine, according to the information gain, among the to-be-recommended information within the range, the to-be-recommended information used for recommendation.

Still further, the processor 602 is specifically configured to acquire, according to the information gain corresponding to the keywords included in the to-be-recommended information within the range, digital vectors corresponding to the multiple pieces of to-be-recommended information within the range; and form a digital vector matrix according to the digital vectors corresponding to the multiple pieces of the to-be-recommended information within the range, apply a preset clustering or classification algorithm, and acquire to-be-recommended information within the range used for recommendation.

The processor 602 is further configured to screen the to-be-recommended information within the range according to the information gain corresponding to the keywords, acquire digital vectors corresponding to screened to-be-recommended information within the range, and form the digital vector matrix according to the digital vectors corresponding to the screened to-be-recommended information within the range.

In addition, the processor 602 is specifically configured to acquire, according to a search word, multiple pieces of to-be-recommended information to form the information set, where the search word includes a search word input by the user, or a search word extracted from association information of the user.

The apparatus may be used to execute the foregoing method embodiments, and the implementation manners are similar. Details are not described herein again.

In the several embodiments provided in the present invention, it should be understood that the disclosed apparatus and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on a plurality of network units. A part or all of the units may be selected according to an actual need to achieve the objectives of the solutions of the embodiments.

In addition, functional units in the embodiments of the present invention may be integrated into one processing unit, or each of the units may exist alone physically, or two or more units are integrated into one unit. The integrated unit may be implemented through hardware, or may also be implemented in a form of a software functional unit.

When the integrated units are implemented in a form of a software functional unit, the integrated units may be stored in a computer-readable storage medium. The software functional unit is stored in a storage medium and includes several instructions for instructing a computer device (which may be a personal computer, a server, or a network device) or a processor to perform a part of the steps of the methods described in the embodiments of the present invention. The foregoing storage medium includes any medium that can store program code, such as a universal serial bus (USB) flash drive, a removable hard disk, a read-only memory (ROM), a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, a person of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. An information recommendation processing method, comprising:
acquiring an information set, wherein the information set comprises multiple pieces of to-be-recommended information, and wherein the to-be-recommended information comprises a time stamp that is used to identify generation time of the to-be-recommended information;
dividing, according to information about an information recommendation time range and the time stamps corresponding to the multiple pieces of to-be-recommended information, the multiple pieces of to-be-recommended information in the information set into to-be-recommended information within the range and to-be-recommended information out of the range; and
determining, among the to-be-recommended information within the range, to-be-recommended information used for recommendation, wherein time identified by the time stamp of the to-be-recommended information within the range is part of the information recommendation time range.

2. The method according to claim 1, wherein determining, among the to-be-recommended information within the range, the to-be-recommended information used for recommendation comprises:
acquiring at least one keyword that is part of the to-be-recommended information within the range;
acquiring, according to the number of pieces of to-be-recommended information within the range, the number of pieces of to-be-recommended information out of the range, the number of the keywords that are part of the to-be-recommended information within the range, and the number of the keywords that are part of the to-be-recommended information out of the range, an information gain corresponding to the keyword; and
determining, according to the information gain, among the to-be-recommended information within the range, the to-be-recommended information used for recommendation.

3. The method according to claim 2, wherein determining, according to the information gain among the to-be-recommended information within the range, the to-be-recommended information used for recommendation comprises:
acquiring, according to the information gain corresponding to the keywords that are part of the to-be-recommended information within the range, digital vectors corresponding to the multiple pieces of to-be-recommended information within the range;
forming a digital vector matrix according to the digital vectors; and
acquiring to-be-recommended information within the range used for recommendation from the digital vector matrix by preset clustering.

4. The method according to claim 3, wherein the method further comprises:
screening the to-be-recommended information within the range according to the information gain corresponding to the keywords; and
acquiring digital vectors corresponding to screened to-be-recommended information, and
wherein forming the digital vector matrix according to the digital vectors comprises forming the digital vector matrix according to the digital vectors corresponding to the screened to-be-recommended information within the range.

5. The method according to claim 2, wherein determining, according to the information gain among the to-be-recommended information within the range, the to-be-recommended information used for recommendation comprises:
acquiring, according to the information gain corresponding to the keywords that are part of the to-be-recommended information within the range, digital vectors corresponding to the multiple pieces of to-be-recommended information within the range;
forming a digital vector matrix according to the digital vectors; and
acquiring to-be-recommended information within the range used for recommendation from the digital vector matrix by classification algorithm.

6. The method according to claim 5, wherein the method further comprises:
screening the to-be-recommended information within the range according to the information gain corresponding to the keywords; and
acquiring digital vectors corresponding to screened to-be-recommended information, and
wherein forming the digital vector matrix according to the digital vectors comprises forming the digital vector matrix according to the digital vectors corresponding to the screened to-be-recommended information within the range.

7. The method according to claim 1, wherein acquiring the information set comprises acquiring, according to a search word, multiple pieces of to-be-recommended information to form the information set, and wherein the search word is input by a user.

8. The method according to claim 1, wherein acquiring the information set comprises acquiring, according to a search word, multiple pieces of to-be-recommended information to form the information set, and wherein the search word is extracted from association information of the user.

9. An information recommendation processing apparatus, comprising:
a memory configured to store instructions; and
a processor coupled to the memory and configured to perform the instructions stored in the memory, wherein the instructions cause the processor to:
acquire an information set, wherein the information set comprises multiple pieces of to-be-recommended information, and wherein the to-be-recommended information comprises a time stamp that is used to identify generation time of the to-be-recommended information;
divide, according to information about an information recommendation time range and the time stamps corresponding to the multiple pieces of to-be-recommended information, the multiple pieces of to-be-recommended information in the information set into to-be-recommended information within the range and to-be-recommended information out of the range; and
determine, among the to-be-recommended information within the range, to-be-recommended information used for recommendation, wherein time identified by the time stamp of the to-be-recommended information within the range is part of the information recommendation time range.

10. The apparatus according to claim 9, wherein the instructions further cause the processor to:
acquire at least one keyword that is part of the to-be-recommended information within the range;
acquire, according to the number of pieces of to-be-recommended information within the range, the number of pieces of to-be-recommended information out of the range, the number of the keywords that are part of the to-be-recommended information within the range, and the number of the keywords that are part of the to-be-recommended information out of the range, an information gain corresponding to the keyword; and
determine, according to the information gain, among the to-be-recommended information within the range, the to-be-recommended information used for recommendation.

11. The apparatus according to claim 10, wherein the instructions further cause the processor to:
acquire, according to the information gain corresponding to the keywords that are part of the to-be-recommended information within the range, digital vectors corresponding to the multiple pieces of to-be-recommended information within the range; and
form a digital vector matrix according to the digital vectors and acquire to-be-recommended information within the range used for recommendation from the digital vector matrix by preset clustering.

12. The apparatus according to claim 11, wherein the instructions further cause the processor to:
screen the to-be-recommended information within the range according to the information gain corresponding to the keywords;
acquire digital vectors corresponding to screened to-be-recommended information; and
form the digital vector matrix according to the digital vectors corresponding to the screened to-be-recommended information within the range.

13. The apparatus according to claim 10, wherein the instructions further cause the processor to:
acquire, according to the information gain corresponding to the keywords that are part of the to-be-recommended information within the range, digital vectors corresponding to the multiple pieces of to-be-recommended information within the range; and
form a digital vector matrix according to the digital vectors and acquire to-be-recommended information within the range used for recommendation from the digital vector matrix by classification algorithm.

14. The apparatus according to claim 13, wherein the instructions further cause the processor to:
screen the to-be-recommended information within the range according to the information gain corresponding to the keywords;
acquire digital vectors corresponding to screened to-be-recommended information; and
form the digital vector matrix according to the digital vectors corresponding to the screened to-be-recommended information within the range.

15. The apparatus according to claim 10, wherein the instructions further cause the processor to acquire, according to a search word, multiple pieces of to-be-recommended information to form the information set, and wherein the search word is input by a user.

16. The apparatus according to claim 10, wherein the instructions further cause the processor to acquire, according to a search word, multiple pieces of to-be-recommended information to form the information set, and wherein the search word is extracted from association information of a user.
